(19) United States
(12) Patent Application Publication
(10) Pub. No.: US 2010/0260997 A1
(43) Pub. Date: Oct. 14, 2010

(54) Phosphate coating for glass wool insulation for use as flexible duct media

(76) Inventors: Patrick F. Aubourg, Granville, OH (US); Russell M. Potter, Hebron, OH (US)

Correspondence Address: MacMillan, Sobanski & Todd, LLC, One Maritime Plaza, Fifth Floor, 720 Water Street, Toledo, OH, 43604, US

(21) Appl. No.: 12/421,760

(22) Filed: Apr. 10, 2009

(51) Int. Cl. F16L 59/147; F16L 59/153; F16L 9/14

(52) U.S. Cl. 428/292.1; 138/145; 138/149; 138/146; 138/128

(57) ABSTRACT

A rotary fibrous insulation product for use as flexible duct media is provided. The fibrous insulation product includes a fibrous insulation pack that is at least partially coated on one major surface with a phosphorus coating layer. The phosphorus coating layer may be formed of one or more phosphorus-containing compound that forms a protective coating over the fibrous pack when sufficient heat is applied. In exemplary embodiments, mono-aluminum phosphate is applied to a major surface of the fibrous pack. The phosphorus-containing compound may be applied to the surface of the fibrous pack in an amount from about 3.0 g P/m² to about 10.0 g P/m². In an alternate embodiment, the phosphorus-containing compound is distributed throughout the insulation pack. A flexible insulated duct formed from the fibrous insulation product is also provided. The flexible insulated duct meets the UL-181 Standard flame penetration test without the need for a scrim layer.

### TECHNICAL FIELD AND INDUSTRIAL APPLICABILITY OF THE INVENTION

The present invention relates generally to rotary fiber insulation, and more particularly, to flexible air ducts that pass the UL-181 flame penetration test where the flexible duct is formed from fibrous wool insulation that has thereon a phosphorus coating layer.

### BACKGROUND OF THE INVENTION

Various types of insulated flexible ducts are known for use in heating and air conditioning applications. Because the ducts are employed in commercial buildings, the ducts are subject to local building codes and regulations. To comply with building codes and receive a UL rating, flexible air ducts must pass a UL-181 Standard. This standard includes many requirements relating to strength, corrosion, mold growth, and burning characteristics. Of particular interest is the flame penetration test of the UL-181 Standard. Conventional flexible ducts do not always pass the flame penetration test. For instance, flexible ducts having a thin layer of insulation have difficulty passing the flame penetration test.

Efforts have been made to improve the flame resistance of insulated flexible ducts. For example, U.S. Pat. No. 5,526,849 to Gray discloses a flexible duct that includes a flame resistant yarn helix disposed between the inner and outer walls of the duct. The yarn structure, however, requires additional material and cost. In addition, U.S. Pat. No. 4,410,014 to Smith teaches a flexible duct that includes a glass fiber scrim laminated to the insulation to improve the possibility of passing the flame resistance of the duct. The glass scrim not only undesirably increases the complexity of manufacture of the duct but also increases the cost.

Accordingly, there exists a need in the art for a fibrous insulation product for use as a flexible air duct that is inexpensive and simple to make, that eliminates the need for expensive veils, and meets the UL-181 flame penetration test.

### SUMMARY OF THE INVENTION

It is an object of the present invention to provide a flexible duct media for forming a flexible insulated duct that includes a fibrous insulation product comprising a plurality of randomly oriented fibers and a binder composition applied to at least a portion of the fibers. The insulation product has a first major surface and a second major surface opposing the first major surface. A phosphorus coating layer formed of at least one phosphorus-containing compound is positioned on at least the first major surface. The fibrous insulation product meets the UL-181 Standard flame penetration test without the need for a scrim layer. In exemplary embodiments, the phosphorus-containing compound is present on the at least the first major surface in an amount from about 4 g P/m² to about 6 g P/m². The phosphorus-containing compound may be selected from mono-aluminum phosphate, sodium polyphosphate, diammonium hydrogen phosphate, aluminum phosphate, dicalcium phosphate, monocalcium phosphate, phosphoric acid, aluminum phosphate, tetrasodium pyrophosphate, tetrapotassium pyrophosphate, sodium hexametaphosphate, potassium tripolyphosphate, monosodium dihydrogen phosphate, and combinations thereof. In exemplary embodiments, the phosphorus-containing compound is mono-aluminum phosphate. Further, the fibers may be selected from glass wool, mineral wool, rock wool, slag wool, basalt wool, and combinations thereof.

It is another object of the present invention to provide a flexible duct media for forming a flexible insulated duct comprising a fibrous insulation product that includes a plurality of randomly oriented fibers and a binder composition applied to at least a portion of the fibers. The binder composition includes a phosphorus-containing compound that is substantially evenly distributed within the fibrous insulation product. In exemplary embodiments, the phosphorus-containing compound is selected from mono-aluminum phosphate and sodium polyphosphate. The phosphorus-containing compound is present in the fibrous insulation product in an amount from about 0.5% to about 6.0%. The fibrous insulation product meets the UL-181 Standard flame penetration test without the need for a scrim layer.

It is yet another object of the present invention to provide a flexible insulated duct that includes a helically coiled reinforcing element defining an inner core for conducting a fluid and a fibrous insulation product wrapped around the reinforcing element. The fibrous insulation product includes a plurality of randomly oriented fibers forming a fibrous pack, a binder composition applied to at least a portion of the fibers, and a phosphorus coating layer formed of at least one phosphorus-containing compound. The insulation pack has an inner major surface and an outer major surface opposing the inner major surface. The phosphorus coating layer is positioned on at least the outer major surface and is positioned such that the phosphorus coating layer is facing outwardly from the inner core. In at least one exemplary embodiment, the phosphorus-containing compound is mono-aluminum phosphate. The phosphorus-containing compound may be present on at least the outer major surface in an amount from about 4 g P/m² to about 6 g P/m². In exemplary embodiments, the phosphorus-containing compound is substantially evenly dispersed on the outer major surface of the fibrous pack. The flexible insulated duct may also include an outer jacket covering the fibrous insulation product, where the outer jacket forms an outer layer of the flexible insulated duct. The flexible insulated duct meets the UL-181 Standard flame penetration test without including a scrim layer.

It is an advantage of the present invention that the flexible air duct passes the UL-181 fire penetration test without the need for any scrim positioned on the insulation product.

It is another advantage of the present invention that the phosphorus-containing compound does not degrade under typical storage temperatures and humidities.

It is also an advantage of the present invention that the flexible duct is inexpensive to manufacture at least partially due to the elimination of the conventional scrim attached to conventional insulation products or at least to the use of lower-weight, less-expensive scrim.

It is still another advantage of the present invention that applying the phosphorus-containing compound to the surface of the fibrous pack concentrates the phosphorus-containing compound on the surface facing the heat for an effective and even superior fire resistance.

It is a feature of the present invention that the phosphorus-containing compound may either be applied to the surface of the fibrous insulation or included with the binder composition to incorporate the phosphorus within the fibrous pack.

It is a feature of the present invention that the phosphorus-containing compound is evenly or substantially evenly dispersed on one or both major surfaces of the fibrous insulation pack.

It is also a feature of the present invention that the fibrous insulation product meets the UL-181 Standard flame penetration test.

It is yet another feature of the present invention that the fibrous insulation product is formed of an insulation pack that is at least partially coated on at least one major surface with a phosphorus coating layer.

It is a further feature of the present invention that the phosphorus-containing compound is applied to the surface of the fibrous pack in an amount of at least 4 g P/m².

It is still another feature of the present invention that the fibrous insulation product may be used as a flexible duct media to form an insulated air duct.

It is also another feature of the present invention that the flexible air duct is able to pass the UL-181 fire penetration test with a substantially lighter scrim than what would otherwise, conventionally, be necessary.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a rotary fibrous wool insulation product containing a fibrous pack having thereon a coating layer containing phosphorus according to one embodiment of the present invention;

FIG. 2 is a perspective view, partially cut away, of a rotary fibrous wool insulation product having a coating layer containing phosphorus on one major surface thereof according to at least one embodiment of the present invention,

FIG. 3 is a schematic illustration of a manufacturing line for producing a rotary fibrous wool product having a coating layer containing phosphorus on one major surface thereof according to at least one embodiment of the present invention;

FIG. 3a is a schematic illustration of a manufacturing line similar to that of FIG. 3, but showing the application of the coating layer containing phosphorus to both major surfaces of the fibrous wool insulation product;

FIG. 4 is a perspective view, partially cut away, of a length of a rotary fibrous wool product formed into a flexible air duct according to one aspect of the invention; and

FIG. 5 is a schematic illustration similar to that of FIG. 3, but showing an alternate embodiment of the manufacturing line of FIG. 3 where the phosphorus-containing compound is applied to the fibers along with the binder.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables figures, and text presented in the cited references.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element or intervening elements may be present. In addition, the terms “UL-181 Standard flame penetration test” and “UL-181 flame penetration test” may be used interchangeably herein. Also, the terms “phosphorus coating layer”, “phosphorus-containing coating layer”, and “coating layer containing phosphorus” may be interchangeably used herein.

The present invention relates to a fire resistant rotary fibrous insulation product for use as flexible duct media. The fibrous insulation product is formed of an insulation pack that is at least partially coated on one or both major surfaces with a coating layer containing phosphorus. Alternatively, a phosphorus-containing material is internally located within the insulation pack. In exemplary embodiments, a phosphorus-containing compound such as mono-aluminum phosphate is applied to at least one major surface of the insulation pack as the phosphorus coating layer. The fibrous insulation product may be used to form a flexible air duct that meets the UL-181 Standard flame penetration test without the need for a scrim layer that is conventionally positioned on flexible air ducts or with a lighter-weight scrim than would otherwise conventionally be required.

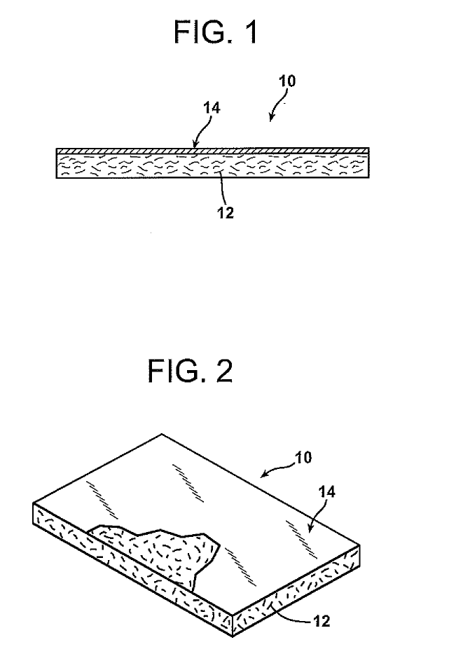

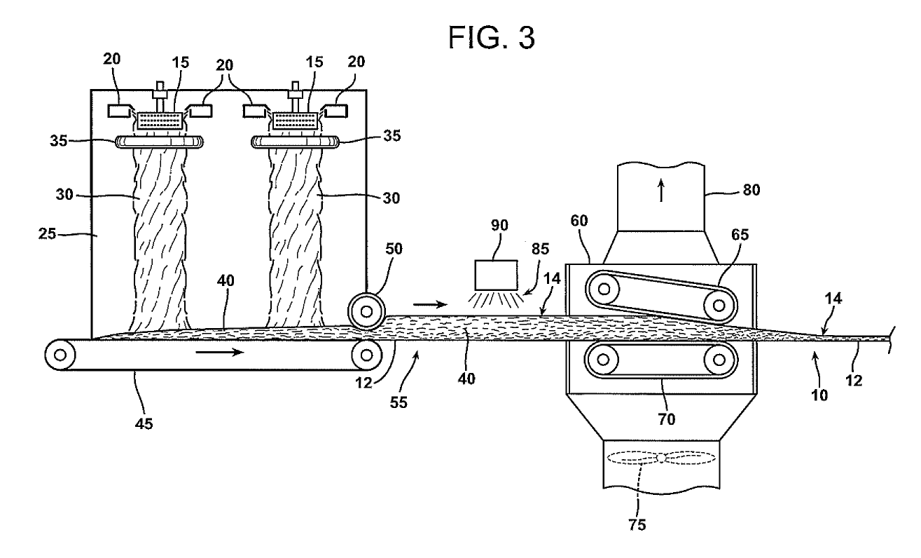

The fibrous insulation product 10 is depicted generally in FIG. 1. The fibers forming the fibrous insulation pack 12 may be formed from any silicate glass fibers such as, but not limited to, glass wool, mineral wool, rock wool, slag wool, and/or basalt wool. Continuous fibers and/or multi-component fibers such as bicomponent or tricomponent fibers may also be used in forming the insulation pack 12, provided that the multi-component fibers are silica-based.

The phosphorus coating layer 14 is positioned on a major surface of the fibrous insulation pack 12 and covers or substantially covers at least one major surface of the insulation pack 12. The phosphorus coating layer 14 may be formed of phosphorus-containing compound(s) that form a protective coating over the fibrous pack 12 when sufficient heat is applied. Suitable examples of phosphorus-containing compounds for use in the phosphorus coating layer 14 include mono-aluminum phosphate (MAP), sodium polyphosphate (SPP), diammonium hydrogen phosphate (DAP), aluminum phosphate, dicalcium phosphate, monocalcium phosphate, phosphoric acid, aluminum phosphate, tetrasodium pyrophosphate, tetrapotassium pyrophosphate, sodium hexametaphosphate, potassium tripolyphosphate, monosodium dihydrogen phosphate, and combinations thereof. It is to be understood that the present invention relates to the use of phosphorus-containing compounds in general for providing resistance flame penetration in accordance with the UL181 flame penetration test and that the invention is not limited by the specific phosphorus-containing compounds listed herein. The phosphorus coating layer 14 may also contain additives such as various binders, silica, and/or borates. In at least one exemplary embodiment, the phosphorus-containing compound is mono-aluminum phosphate.

In exemplary embodiments, mono-aluminum phosphate is applied to the fibrous pack 12 either as coating layer 14 or throughout out the glass fiber insulation 12. U.S. Pat. No. 5,503,920 to Alkire et al. teaches that heat and humidity treatment to an alumina and phosphate coating on glass fibers improves the strength of the glass wool to which it is applied. U.S. Pat. No. 5,284,700 to Strauss et al. hypothesizes and French Patent 2,864,828 to Bernard et al. asserts that this improvement in strength is the result of the phosphorus being mobilized by the heat and humidity treatment and that, on high temperature heat-treatment, the phosphorus reacts with the glass fiber components to form a refractory crystalline coating on the fibers. Although not wishing to be bound by any particular theory, it is believed that the use of mono-aluminum phosphate is particularly effective in providing to the glass fiber insulation resistance to the flame in the UL-181 flame penetration test due, at least in part to, the mobility of the phosphate components under the heating conditions which improves coverage over the fibers in the pack 12.

In one exemplary embodiment, mono-aluminum phosphate is applied to the fibrous pack 12 as the phosphorus coating layer 14. The phosphorus-containing compound is applied to a major surface of the fibrous pack 12 in an amount sufficient to achieve fire resistant properties and pass the UL-181 flame penetration test. It is to be understood that an effective level of phosphorus addition will depend on the particular and specific characteristics of the glass fiber insulation. For instance, a higher quality, heavier density insulation pack 12 will require a lower level of phosphorus addition whereas a lower quality, lighter density insulation pack 12 will require a higher level of phosphorus addition in order to pass the UL-181 flame penetration test. The phosphorus-containing compound may be applied to the surface of the fibrous pack in an amount of at least 4 g P/m². In some exemplary embodiments, the phosphorus-containing compound is applied to the surface of the fibrous pack 12 in an amount from about 14 g P/m² to about 16 g P/m². At these levels of phosphorus addition, the need for a scrim is eliminated and a consistent passing of the UL-181 Standard Flame Penetration Test is achieved.

In other exemplary embodiments, the phosphorus-containing compound may be applied to the surface of the fibrous pack in an amount from about 3.0 g P/m² to about 10.0 g P/m², or from about 4.0 g P/m² to about 6.0 g P/m². At these levels of phosphorus addition, the need for scrim is typically eliminated and a consistent passing of the UL-181 Standard flame resistance test is obtained. It has been determined that phosphorus addition at levels lower then about 3.0 g P/m² convey insufficient protection and phosphorus addition levels greater than about 16 g P/m² do not significantly increase protection within the parameters of the UL-181 flame penetration test.

It is also to be appreciated that a lesser quantity of a phosphorus-containing compound (e.g., less than about 3 g P/m²) added to the insulation pack 12, although it will not eliminate the need for scrim altogether, will generally permit the use of a lighter scrim and the construction of a flexible duct that will reliably pass the UL-181 Standard flame penetration test. The amount of phosphorus-containing compound(s) necessary in order for the coated fibers of the insulation pack 12 to pass the UL-181 flame resistance test depends on the viscosity of the glass from which the wool insulation is made. For example, the lower the viscosity of the glass at the UL-181 flame penetration test temperature of 1425° F., the greater the amount of phosphorus that must be added to pass the UL-181 flame penetration test. Applying the phosphorus-containing compound to the surface of the fibrous pack 12 concentrates the phosphorus-containing compound on the surface facing the heat for an effective and even superior fire resistance. In addition, application of the phosphorus-containing compound to a major surface of the insulation pack 12 reduces the overall amount of phosphorus added to the pack 12 compared to applying the phosphorus-containing compound throughout the insulation pack 12, as discussed in detail below. The concentration of phosphorus on an area weight basis is greater if the phosphorus-containing compound is located throughout the pack 12, although the concentration of the phosphorus-containing compound is comparatively less than an application of the phosphorus to the surface of the pack 12.

The coating layer 14 containing the phosphorus-containing compound may be applied to a major surface of the fibrous pack 12 during or after the manufacture of the fibrous pack 12. The phosphorus coating layer provides the fire resistance necessary for the flexible air duct incorporating the fibrous insulation product 10 to pass the UL-181 Standard flame resistance test. It is to be appreciated that although glass fiber insulation is discussed herein, other silicate fibers such as mineral wool, rock wool, slag wool, and basalt wool may alternatively or additionally be used in forming the fibrous pack 12.

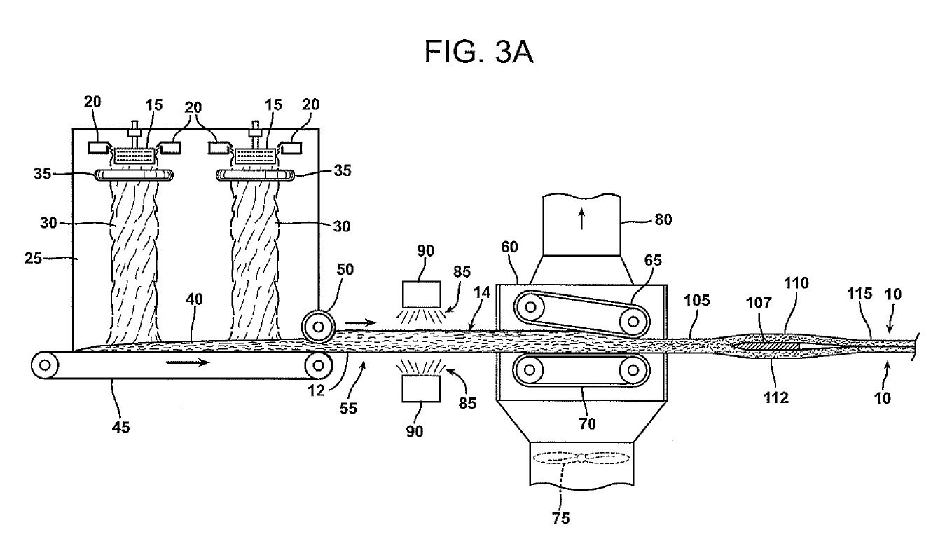

Turning to FIG. 3, glass may be melted in a tank (not shown) and supplied to a fiber forming device such as a fiberizing spinner 15. The spinners 15 are rotated at high speeds. Centrifugal force causes the molten glass to pass through the holes in the circumferential sidewalls of the fiberizing spinners 15 to form glass fibers. Single component glass fibers of random lengths may be attenuated from the fiberizing spinners 15 and blown generally downwardly, that is, generally perpendicular to the plane of the spinners 15, by blowers 20 positioned within a forming chamber 25. The blowers 20 turn the fibers downward to form a veil or curtain 30. Non-limiting examples of glass fibers that may be used in the present invention are described in U.S. Pat. No. 6,527,014 to Aubourg; U.S. Pat. No. 5,932,499 to Xu et al.; U.S. Pat. No. 5,523,264 to Mattison; and U.S. Pat. No. 5,055,428 to Porter; the contents of which are expressly incorporated by reference in their entirety.

The glass fibers, while in transit in the forming chamber 25 and while still hot from the drawing operation, are sprayed with an aqueous binder composition by an annular spray ring 35 so as to result in a distribution of the binder composition throughout the formed insulation pack 40. Water may also be applied to the glass fibers in the forming chamber 25 (not illustrated), such as by spraying, prior to the application of the binder composition to at least partially cool the glass fibers. It is to be noted that not all binders used in conjunction with glass wool insulation are compatible with all phosphorus-containing compounds. For instance, conventional binders such as phenol-formaldehyde and urea-formaldehyde are not compatible with mono-aluminum phosphate (MAP). Thus, the choice of which phosphorus-containing compound to use and/or the method of application of that particular phosphorus-containing compound will be influenced by the binder used in that particular application.

As one example, when the phosphorus-containing compound is applied such that the phosphorus is located throughout the insulation pack and a phenol-formaldehyde binder is used, a sodium polyphosphate, which is compatible with the phenol-formaldehyde binder, may be used instead of mono-aluminum phosphate, which is not. However, the mono-aluminum phosphate may be applied to the surface of the pack 12 after the phenol-formaldehyde binder is cured. Mono-aluminum phosphate could be applied with binders compatible with acid conditions such as, but not limited to, a polycarboxylic acid based binder, a polyacrylic acid glycerol (PAG) binder, or a polyacrylic acid triethanolamine (PAT) binder. Such binders are known for use in connection with rotary fiberglass insulation. Examples of such binder technology are found in U.S. Pat. No. 5,318,990 to Straus; U.S. Pat. No. 5,340,868 to Straus et al.; U.S. Pat. No. 5,661,213 to Arkens et al.; U.S. Pat. No. 6,274,661 to Chen et al.; U.S. Pat. No. 6,699,945 to Chen et al.; and U.S. Pat. No. 6,884,849 to Chen et al., each of which is expressly incorporated entirely by reference. It is also envisioned that a bio-based binder may be suitable for use in the present invention. The binder may be present in an amount from about 3.0% to about 8.0% by weight of the total product, and in exemplary embodiments, from about 4.0% to about 6.0% by weight of the total product.

The glass fibers having the uncured resinous hinder adhered thereto may be gathered and formed into an uncured pack 40 on an endless forming conveyor 45 within the forming chamber 25 with the aid of a vacuum (not shown) drawn through the insulation pack 40 from below the forming conveyor 45. The residual heat from the glass fibers and the flow of air through the insulation pack 40 during the forming operation are generally sufficient to volatilize a majority of the water from the binder before the glass fibers exit the forming chamber 25, thereby leaving the remaining components of the binder on the fibers as a viscous or semi-viscous high-solids liquid. The coated uncured pack 40, which is in a compressed state due to the flow of air through the pack 40 in the forming chamber 25, is then transferred out of the forming chamber 25 under exit roller 50 to a transfer zone 55 where the fibrous pack 40 vertically expands due to the resiliency of the glass fibers.

Before fibrous pack 40 enters the oven 60, the pack 40 is sprayed with a phosphorus-containing compound 85 from a suitable applicator device 90. The phosphorus-containing compound 85 may be applied by conventional methods such as by the spraying device 90 or by an application roller (not shown) to achieve a desired amount of the phosphorus-containing compound on the fiber pack 40. Other application methods such as a kiss roll, dip-draw, or slide are easily identifiable by one of skill in the art. As discussed above, the phosphorus-containing compound may be added in an amount from about 3.0 g P/m² to about 14.0 g P/m² to form a coating layer 14 containing phosphorus on the fibrous pack 12. The phosphorus-containing compound 85 is evenly or substantially evenly applied over a major surface of the fibrous pack 40 to form a phosphorus-coating layer 14. As used herein, the term “substantially evenly applied” is meant to denote that the phosphorus-containing compound is evenly or nearly evenly applied to the surface of the pack 40. In exemplary embodiments, the phosphorus coating layer 14 penetrates into the insulation pack 40 to a depth of about 0.5 mm to about 2 mm. The phosphorus coating layer 14 provides fire protection to the fibrous insulation product 10. In a related embodiment, the phosphorus-containing compound may be applied to one or more of the minor surfaces of the cured pack 40.

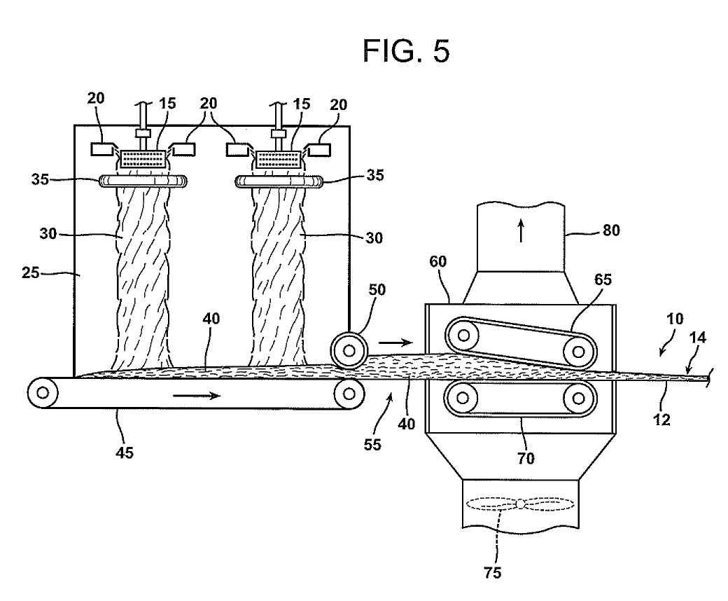

The expanded pack 40 coated with a phosphorus coating layer 14 is then fed between two endless conveyors 65, 70 extending through an oven 60. The pack 40 is conveyed through the oven 60 where heated air is blown through the insulation pack 40 to evaporate any remaining water in the binder, cure the binder, and rigidly bond the fibers together in the insulation pack 40. Specifically, heated air is forced though a fan 75 through the lower oven conveyor 70, the insulation pack 40, the upper oven conveyor 65, and out of the curing oven 60 through an exhaust apparatus 80. The cured binder imparts strength and resiliency to the insulation product 10. Also, in the curing oven 60, the pack 40 may be compressed by upper and lower foraminous oven conveyors 65, 70 to form a fibrous wool insulation product 10 having a predetermined thickness formed of the cured insulation pack 12 and a coating layer 14 including a phosphorus-containing compound. The distance between the lower flight of the belt 65 and the upper flight of the belt 70 determines the thickness of the fibrous pack 40. It is to be appreciated that although FIGS. 3, 3A, and 5 depict the conveyors 60, 70 as being at an angle relative to each other, they may alternatively be positioned in a substantially parallel orientation.

In another exemplary embodiment illustrated in FIG. 3a, the fibrous pack 40 is formed as discussed in detail above with respect to FIG. 3. A phosphorus-containing compound 85 is then applied to first and second major surfaces of the fibrous pack 40 by a suitable application device. Similar to the embodiment discussed above, the uncured pack 40, with a phosphorus-containing layer 14 on both major surfaces, is heated in the oven 60 to remove water from the binder, cure the binder, and bond the fibers together. The insulation product 105 that emerges is then bisected horizontally into two layers 110, 112 by a slitting device 107. The two layers 110, 112 are subsequently brought back together as a single insulation unit 115 and rolled (not shown) for shipping or storage.

The presence of water, dust, and/or other microbial nutrients in the rotary fiberized insulation product 10 may support the growth and proliferation of microbial organisms. Bacterial and/or mold growth in the insulation product may cause odor, discoloration, and deterioration of the wool insulation product 10. To inhibit the growth of unwanted microorganisms such as bacteria, fungi, and/or mold in the insulation product 10, the insulation pack 12 may be treated with one or more anti-microbial agents, fungicides, and/or biocides. The anti-microbial agents, fungicides, and/or biocides may be added during manufacture or in a post manufacture process of the fibrous wool insulation product 10. In addition, pigments, colorants, and/or other conventional additives may be included in the wool insulation product 10.

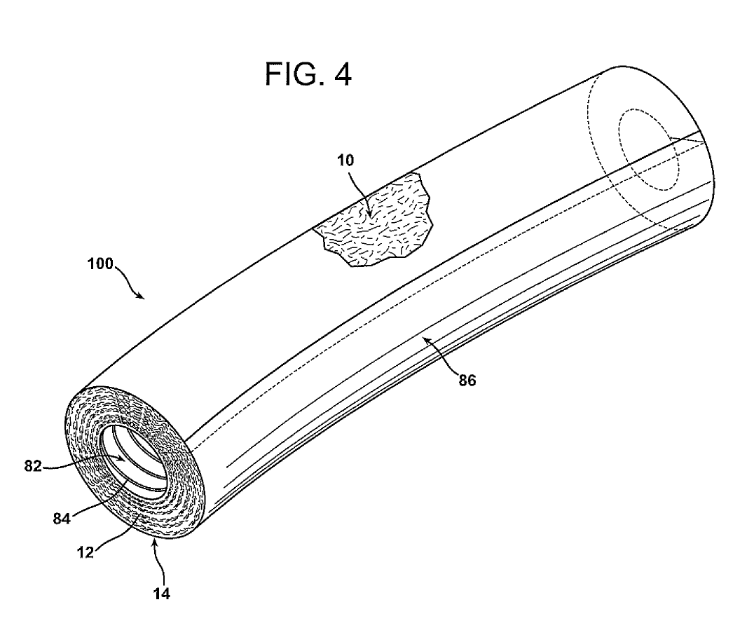

In at least one exemplary embodiment illustrated in FIG. 4, the fibrous insulation product 10 may be used as a flexible duct media to form a flexible insulated air duct 100 having an inner core 82 for conducting air (or other fluid). For example, a length of the fibrous insulation product 10 may be wrapped around a reinforcing element 84 to provide structural rigidity to the duct 100. Typically, the reinforcing element is a continuous helically coiled, resilient wire extending along the length of the duct 100 and forming the inner core 82. Generally, the coiled reinforcing element has spaced convolutions. The reinforcing element 84 can be positioned at various locations in the duct, but is usually either attached to or encapsulated in the insulation product 10, which forms the inner wall of the duct 100. In one exemplary embodiment, the reinforcing element is a helically coiled, resilient wire encapsulated in the inner wall. The reinforcing element may be formed of a metallic material such as steel, aluminum, a metal alloy, a plastic material, or a plastic-coated metallic material. Usually, the reinforcing element is formed of a wire of spring steel. The diameter of the wire is dictated by the size of the air duct.

The insulation product 10 is positioned on the reinforcing element 84 such that the phosphorus coating layer 14 on the fibrous pack 12 is facing outwardly and away from the inner core 82. In other words, the phosphorus coating layer 14 is positioned on an outer major surface fibrous pack 12 and the insulation product 10 is positioned on the flexible duct 100 so that a flame will reach the phosphorus coating layer 14 prior to reaching the inner fibrous layer 12. An outer jacket 86, such as a plastic film, may cover the fibrous insulation product 10 and form an outer layer of the flexible duct 100.

It is to be appreciated that although a scrim is not necessary in the instant invention for fire protection, the flexible duct 100 may also include a layer of scrim material to provide additional strength and reinforcement to the duct 100. The layer of scrim may be interposed between the outer jacket 86 and the layer of insulation 10. In one or more exemplary embodiments, the scrim is wrapped about and laminated to the outer surface of the layer of insulation. The scrim material can be any suitable woven or non-woven material. In exemplary embodiments, the scrim is a non-woven glass scrim. An exemplary structure for the flexible duct including a scrim is shown and described in U.S. Pat. No. 4,410,014 to Smith, the contents of which are incorporated by reference in their entirety.

Although the inventive fiber air duct formed of the rotary fibrous wool insulation product passes the United States' fire resistance test set forth in UL-181, it is insufficient to pass the more stringent standards set forth in the corresponding Canadian UL test. According to UL-181, the Standard for Factory Made Air Ducts and Air Connectors, the duct, when cut open and placed over a flame at 1425° F. (774° C.) with the outside of the duct in contact with the flame, must be able to hold a 3.6 kg weight for a time period of 30 minutes. If the weight falls through the sample or the flame penetrates the sample, the sample fails the test. The test is described in detail in U.S. Pat. No. 5,526,849 to Gray, which is hereby incorporated by reference in its entirety. The corresponding Canadian UL test is similar in its testing procedures, but the temperature requirement is significantly higher at 1560° F.

Phosphorus-containing compounds located throughout the fibrous pack provide the necessary heat-resistance to allow the inventive ducts to pass the Canadian UL flame penetration test that corresponds to the U.S. UL-181 flame penetration test. In an alternate embodiment depicted in FIG. 5, an uncured pack 12 is formed as described in detail above with respect to FIG. 3, except that the phosphorus-containing compound is applied to the individual fibers with the binder, or by itself as a binder, by the annular spray ring 35. The phosphorus-containing compound may be placed in admixture with the binder composition and applied to the fibers as they emerge from the fiberizing spinner 15. By mixing the phosphorus-containing compound with the binder, the phosphorus-containing compound is located throughout the fibrous pack 12 (and subsequently the formed wool insulation product 10). In exemplary embodiments, the phosphorus-containing compound is evenly or substantially evenly positioned throughout the fibrous pack 12. It is to be appreciated that one or more annular spray rings may be positioned downstream of the annular spray ring 35 to apply the phosphorus-containing compound separately from the binder. When the phosphorus-containing compound is applied by an annular spray ring, the compound may be applied as an aqueous mixture so that a residue of the compound remains on the fiber surface after drying.

As discussed above with respect to FIG. 3, the uncured pack 40 passes out of the forming chamber 25, through the expansion zone 55, and is compressed to a desired thickness by conveyor belts 65, 70 in the oven 60. Since the phosphorus-containing compound is located on the fibers, there is no need to separately apply a coating of the phosphorus-containing compound to the surface of the pack 40. However, separately applying the phosphorus-containing compound to the pack 40 similar to that shown in FIG. 3 and FIG. 3a is not outside the scope of the invention. It is also envisioned that the phosphorus-containing compound may also be applied to one or more of the minor surfaces of the cured pack 12. The inclusion of phosphorus in an amount sufficient to yield 0.5% phosphorus by weight in the pack 12 is necessary to significantly improve the flame penetration performance.

There are numerous advantages provided by the present invention. For instance, the flexible duct formed from the rotary fibrous wool insulation product meets the stringent requirements for passing the UL-181 flame penetration test without the need for conventionally used scrims. Because scrims are expensive and the application of the scrim to the wool insulation product creates an extra manufacturing step, the wool insulation product saves both time and money. In those flexible duct products with a metalized jacket, it is common practice to incorporate the scrim in the jacket where it improves flame penetration behavior as well as reinforces the jacket. The present invention eliminates the need for so robust a scrim as would otherwise be necessary.

Having generally described this invention, a further understanding can be obtained by reference to certain specific examples illustrated below which are provided for purposes of illustration only and are not intended to be all inclusive or limiting unless otherwise specified.

### EXAMPLES

In the following examples, the products were tested in accordance with the procedures set forth in UL-181. In particular, the flexible duct is cut open and flattened. A 55.9 cm by 55.9 cm sample is cut from the duct and mounted on a frame. The frame is then placed over a flame at 1425° F. (774° C.) or, for the Canadian flame penetration test, at 1560° F. (849° C.) with the outside of the duct (i.e., the phosphorus-coated side) in contact with the flame. The sample is loaded with a 3.6 kg weight over an area 2.5 cm by 10.2 cm. Failure occurs if either the weight falls through the sample or the flame penetrates the sample.

### Example 1

Test material: R4.2 FDM (flexible duct media)

Scrim: Glass filament scrim with an area weight of 0.54 oz/yd² (0.018 kg/m²)

Phosphorus was applied to the surface of the FDM by spraying an aqueous solution of mono-aluminum phosphate (MAP) directly onto the surface of the FDM. The phosphate solution was permitted to dry for a time period of at least 30 minutes.

All test samples were tested in accordance with the testing procedures according to UL-181 as set forth above.

TABLE 1

| | | Target Phosphate | | | |
|---|---|---|---|---|---|
| | | Coating | Area | Time to | Time Stopped |
| Test | | Concentration | Weight | Failure | Without Failure |
| Sample | Scrim | g P/m² | p | (min) | (min) |
| 1 | yes | none | 0.075 | — | 45 |
| | yes | none | 0.096 | — | 45 |
| 2 | yes | 6.0 | 0.104 | — | 45 |
| | yes | 6.0 | 0.103 | — | 45 |
| 3 | no | none | 0.087 | 1 | — |
| | no | none | 0.090 | 7 | — |
| 4 | no | 6.0 | 0109 | — | 60 |
| | no | 6.0 | 0.107 | — | 60 |

The data shown in Table 1 demonstrates that a 6% phosphorus addition to the surface of the flexible duct media resulted in at least as good flame penetration resistance compared to conventional FDM with a scrim as is currently used in the industry.

### Example 2

Test material: R6 FDM (flexible duct media)

Scrim: None

Phosphate was applied to the glass fibers within the fibrous pack with an acrylic binder in the ratios indicated in Table 2. In samples 5-10, a surfactant was added to the binder. All of the samples were tested by a test set-up designed to mimic the UL-181 flame penetration test. The samples were placed without scrim on the top of an electrically heated furnace at 1425° F. with an open top having an area of 8 inches by 8 inches. A 1 inch ceramic rod was placed across the top of the phosphorus-containing FDM to mimic the compression of the weight used in the UL-181 flame penetration test. The time to failure was recorded when the first appearance of a hole at least 8 mm in area somewhere in the FDM as measured by a camera looking up at the FDM through a port at the bottom of the furnace. All tests were stopped at 120 minutes.

TABLE 2

| | | | | | Time to | % Stopped |
|---|---|---|---|---|---|---|
| | | | | Target | Failure | at 120 min |
| | | | | Phosphate | (average | without |
| Test | Description | LOI | Surfactant | Concentration | of 6) | Failure |
| Sample | MAP:Binder | (%) | (%) | (%) | (min) | (min) |
| 5 | 1:1 | 5.0 | none | 0.7 | 44 | 0 |
| 6 | 1:1 | 7.5 | none | 1.1 | 74 | 0 |
| 7 | 1:1 | 10.0 | none | 1.5 | 91 | 17 |
| 8 | 2:1 | 5.0 | none | 1.0 | 57 | 0 |
| 9 | 2:1 | 7.5 | none | 1.5 | 104 | 33 |
| 10 | 2:1 | 10.0 | none | 2.0 | 120 | 100 |
| 11 | 1:1 | 5.0 | 0.02 | 0.7 | 63 | 0 |
| 12 | 1:1 | 5.0 | 0.02 | 1.0 | 72 | 0 |

The data shown in Table 2 demonstrates that the inclusion of phosphate throughout the FDM by adding MAP to the binder is effective in providing flame penetration resistance and that this flame penetration resistance increases with an increase in the phosphate concentration. Additionally, the data suggests that better distribution of the phosphate on the fibers through surfactant addition increases the effectiveness at any given phosphate level.

### Example 3

Phosphate was added at a target level of 2.4% phosphate throughout the insulation pack by spraying a mono-aluminum phosphate solution through the binder-application rings as the sole binder material in accordance with the process depicted in FIG. 5. The resulting flexible duct media (FDM) was further treated by heating at 120° F. and 90% relative humidity for 3 days. The FDM was then stored overnight at 300° F. and tested in accordance with the UL-181 Flame Penetration Test (U.S.), the corresponding Canadian procedure, and by the UL-181 mimic test described in Example 2. The results are shown in Table 3.

TABLE 3

| | Tem- | Dura- | |
|---|---|---|---|
| | perature | tion | |
| Test | (° F.) | (min) | Comments |
| mimic | 1425 | 120 | stopped after 120 minutes; no evidence for |
| | | | degradation |
| mimic | 1517 | 120 | stopped after 120 minutes; some large cracks |
| | | | penetrating <1 cm into the wool |
| mimic | 1560 | 120 | stopped after 120 minutes; layers formed |
| | | | which cracked and curled away from away |
| | | | from surface eroding to a depth <2 cm total |
| mimic | 1560 | 120 | stopped after 120 min; no layer curling; 1 |
| | | | large crack ~1 cm deep |
| UL-181 | 1425 | 30 | stopped after 30 minutes; some large cracks |
| (U.S.) | | | penetrating <1 cm into the wool |
| UL-181 | 1560 | 30 | stopped after 30 minutes; some large cracks |
| (Canada) | | | penetrating <1 cm into the wool; some areas |
| | | | of slight erosion |
| UL-181 | 1560 | 30 | stopped after 30 minutes; some large cracks |
| (Canada) | | | penetrating <1 cm into the wool |

The data in Table 3 demonstrates that at a 2.4% level of inclusion of phosphorus within the insulation pack, the flexible duct media formed from the insulation pack had better than the required resistance to meet both the U.S. and the Canadian UL-181 flame penetration test requirements.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A flexible duct media for forming a flexible insulated duct comprising:
a fibrous insulation product including:
a plurality of randomly oriented fibers; and
a binder composition applied to at least a portion of said fibers, said insulation product having a first major surface and a second major surface opposing said first major surface; and
a phosphorus coating layer formed of at least one phosphorus-containing compound positioned on at least said first major surface,
wherein said fibrous insulation product meets the UL-181 Standard flame penetration test.

2. The flexible duct media of claim 1, wherein said phosphorus-containing compound is selected from mono-aluminum phosphate, sodium polyphosphate, diammonium hydrogen phosphate aluminum phosphate, dicalcium phosphate, monocalcium phosphate, phosphoric acid, aluminum phosphate, tetrasodium pyrophosphate, tetrapotassium pyrophosphate, sodium hexametaphosphate, potassium tripolyphosphate, monosodium dihydrogen phosphate and combinations thereof.

3. The flexible duct media of claim 2, wherein said phosphorus-containing compound is mono-aluminum phosphate.

4. The flexible duct media of claim 2, wherein said phosphorus-containing compound is present on said at least said first major surface in an amount from about 4 g P/m² to about 6 g P/m².

5. The flexible duct media of claim 1, wherein said fibrous insulation product meets the UL-181 Standard flame penetration test without the need for a scrim layer.

6. The flexible duct media of claim 1, wherein said fibers are selected from glass wool, mineral wool, rock wool, slag wool, basalt wool and combinations thereof.

7. A flexible duct media for forming a flexible insulated duct comprising:
a fibrous insulation product including:
a plurality of randomly oriented fibers; and
a binder composition applied to at least a portion of said fibers, said binder composition including a phosphorus-containing compound, said phosphorus-containing compound being substantially evenly distributed within said fibrous insulation product,
wherein said fibrous insulation product meets the UL-181 Standard flame penetration test.

8. The flexible duct media of claim 7, wherein said phosphorus-containing compound is selected from mono-aluminum phosphate, sodium polyphosphate, diammonium hydrogen phosphate, aluminum phosphate, dicalcium phosphate, monocalcium phosphate, phosphoric acid, aluminum phosphate, tetrasodium pyrophosphate, tetrapotassium pyrophosphate, sodium hexametaphosphate, potassium tripolyphosphate, monosodium dihydrogen phosphate and combinations thereof.

9. The flexible duct media of claim 8, wherein said phosphorus-containing compound is selected from mono-aluminum phosphate and sodium polyphosphate.

10. The flexible duct media of claim 7, wherein said phosphorus-containing compound is present in said fibrous insulation product an amount from about 0.5% to about 6.0% phosphorus in said fibrous insulation product.

11. The flexible duct media of claim 7, wherein said fibrous insulation product meets the UL-181 Standard flame penetration test without the need for a scrim layer.

12. A flexible insulated duct comprising:
a helically coiled reinforcing element defining an inner core for conducting a fluid; and
a fibrous insulation product wrapped around said reinforcing element, said fibrous insulation product including:
a plurality of randomly oriented fibers forming a fibrous pack;
a binder composition applied to at least a portion of said fibers, said fibrous pack having an inner major surface and an outer major surface opposing said inner major surface; and
a phosphorus coating layer formed of at least one phosphorus-containing compound positioned on at least said outer major surface, said phosphorus coating layer facing outwardly from said inner core,
wherein said flexible insulated duct meets the UL-181 Standard flame penetration test.

13. The flexible insulted duct of claim 12, wherein said phosphorus-containing compound is present on said outer major surface in an amount from about 3 g P/m² to about 10 g P/m².

14. The flexible insulated duct of claim 13, wherein said phosphorus-containing compound is selected from mono-aluminum phosphate, sodium polyphosphate, diammonium hydrogen phosphate, aluminum phosphate, dicalcium phosphate, monocalcium phosphate, phosphoric acid, aluminum phosphate, tetrasodium pyrophosphate, tetrapotassium pyrophosphate, sodium hexametaphosphate, potassium tripolyphosphate, monosodium dihydrogen phosphate and combinations thereof.

15. The flexible insulted duct of claim 14, wherein said phosphorus-containing compound is mono-aluminum phosphate.

16. The flexible insulted duct of claim 13, wherein said flexible duct meets the UL-181 Standard flame penetration test without including a scrim layer.

17. The flexible insulated duct of claim 13, further comprising:
an outer jacket covering said fibrous insulation product, said outer jacket forming an outer layer of said flexible insulated duct.

18. The flexible insulated duct of claim 12, wherein said phosphorus-containing compound is substantially evenly dispersed on said outer major surface of said fibrous pack.

19. The flexible insulated duct of claim 18, wherein said fibers are selected from glass fibers, mineral wool, rock wool, slag wool, basalt wool and combinations thereof.

20. The flexible insulated duct of claim 19, wherein said fibrous insulation product further comprises a member selected from anti-microbial agents, fungicides, biocides, pigments, colorants and combinations thereof.
